(19) United States
(12) Patent Application Publication
(10) Pub. No.: US 2002/0161780 A1
(43) Pub. Date: Oct. 31, 2002

(54) Browser rewind and replay feature for transient messages wherein the messages are stored automatically when they are initially rendered and replayed when selected

(75) Inventors: Rabindranath Dutta, Austin, TX (US); Michael Richard Cooper, Austin, TX (US); Kamal Chandrakant Patel, Cedar Park, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 09/843,059

(22) Filed: Apr. 26, 2001

(51) Int. Cl. G06F 7/00

(52) U.S. Cl. 707/103 R

(57) ABSTRACT

A system, method and program of the invention enables a user to view, at a later time, transitory messages, e.g., advertisements, that the user may have previously missed. The multimedia objects containing the messages are stored automatically without user action when the multimedia object is rendered at the client. In response to a user action, a list of the stored multimedia objects are displayed to the user along with selectable controls for rewinding and replaying the list of stored multimedia objects. The user may select each multimedia object from the list one at a time for replaying, or the user can use the selectable controls to replay or rewind a succession of the stored multimedia objects. The multimedia objects may include an animated GIF multimedia object, a moving picture type multimedia object, a vector graphic multimedia object, and a static image multimedia object.

### BACKGROUND OF THE INVENTION

1. Field of the Invention

This invention relates to displaying content retrieved from a server in a computer network by a user using a browser application on a client device, and more specifically to a system, method, and program for enabling transitory content that has been dynamically displayed within the browser to be redisplayed to the user at the user's command.

2. Description of the Related Art

The Internet, initially referred to as a collection of “interconnected networks”, is a set of computer networks, possibly dissimilar, joined together by means of gateways that handle data transfer and the conversion of messages from the sending network to the protocols used by the receiving network. When capitalized, the term “Internet”refers to the collection of networks and gateways that use the TCP/IP suite or protocols.

Currently, the most commonly employed method of transferring data over the Internet is to employ the World Wide Web environment, referred to herein as “the Web”. Other Internet resources exist for transferring information, such as File Transfer Protocol (FTP) and Gopher, but have not achieved the popularity of the Web. In the Web environment, servers and clients effect data transfer using the Hypertext Transfer Protocol (HTTP), a known protocol for handling the transfer of various data files (e.g., text, still graphic images, audio, motion video, etc.).

A Web browser on the client enables a user to specify a Web location through a displayed link or by inputting the URL of the location. The Web browser sends the URL request using the HTTP protocol which defines the way in which the Web browser and the Web server communicate with one another. The request is sent to the Internet which determines which server to send the request to. A Web server receives the request using the HTTP protocol; and sends the requested home page, document, or object to the Web browser client. The content is displayed on the client's computer screen through the Web browser.

In some situations, the requested content will contain other embedded objects that are specified by a different URL. These other objects may be located at a different server than the server at which the originally requested content resides. After receiving the originally requested content and a URL of an embedded object, the Web browser sends out a request to the Internet for this other object. The Web browser then embeds this other object/content into the original document as specified by the HTML tags in the original document.

When a user is browsing or accessing Web pages, the Web browser itself, and/or the Web pages being accessed, may include advertisements, or promotional or informational messages. The words “banner advertisements” or “messages”or “ads” will be used interchangeably herein to refer to these advertisements or messages. Typically, banner advertisements are displayed in some portion of the browser or in a separate window other than the window displaying the requested content. An Internet Service Provider (ISP) or On Line Service may cause banner advertisements to be displayed on the client's Web browser independently of any specific content or Web page being accessed. That is, the messages are not associated with or dictated by the content being displayed and thus appear to be randomly generated.

Advertisements can also appear within a given portion of a Web page. Owner's of Web pages may sell banner space within their Web page to advertisers to generate revenue. Owner's of Web pages may also utilize their own advertising. Also, owners of search engines generate revenue by displaying banner advertisements on their home page and along with any displayed search results. Sometimes the content of the banner advertisements are geared to a targeted audience as made evident by the subject matter being searched or by information that may be accessible in cookies stored at the client.

The HTML structure of Web documents in general enables advertisements or other objects to be embedded within a Web page or document. To take advantage of this feature, some Web sites configure their pages such that there is a consistent area on each page where advertisements are displayed. Web page content is then formatted around these predefined areas. Typically, the predefined area has its own URL which is different than the URL used to get the Web page content. The URL for the predefined area usually retrieves an advertisement from a server especially designed to deliver advertisements. As such, when a first URL is used to request a new page from a given Web site, the URL for the predefined area is used to get an advertisement to be displayed in the predefined area. The advertisement is placed in the same position on the Web page, and the content that was retrieved may be modified to fit around this advertisement area. The advertisement server may provide a different advertisement even though the same URL for the advertisement server is being used. As such, each time the same Web page is accessed, a different advertisement may appear. The displayed messages may appear to be dynamically or randomly generated. As such, these banner advertisements are referred to herein as being dynamically and/or randomly generated. That is, a same advertisement does not necessarily appear each time a same Web page is accessed.

The dynamic and random nature of advertisements can be caused by any one of several factors. For example, the embedded object containing advertisement content may be a multimedia object. Not only is such a multimedia object enabled to contain a sequence of static frames played at a given number of frames per second to give a moving picture affect, but the multimedia object may contain a sequence of different advertisements displayed one after the other. Also, as a user accesses different Web pages, each web page may display different advertisements. Also, for a given URL for an embedded object within a given Web page, a server can be constantly changing the advertisement content associated with the given URL. This enables the server to bring in advertising dollars from as many different advertisers as possible by dispersing advertising time and space for any given highly visited Web site amongst the many different advertisers.

It should be noted that although the term randomly generated is used because the advertisements may be different each time a same page is accessed, they may not be truly randomly generated by the advertisement server. That is, the advertisement server may have a very specific algorithm for determining which advertisement to send depending upon a time of the request, the content being requested, and/or one or more attributes of the requester. In other words, target advertising may be used to gear certain advertising to certain types of users at certain times of the day and for certain types of content being requested. In this respect, the advertising is not randomly generated, but generated pursuant to a specific algorithm. Nevertheless, the term randomly generated or dynamically generated is used interchangeably to mean that the advertisement may change independently of any changed or unchanged Web page content. In other words, different requests for a given URL for a specific Web page will not necessarily result in a same advertisement being displayed within that Web page each time that it is requested and rendered to the display.

As such, if a user “misses” an advertisement, the user may not necessarily be able to just request the same Web page and expect to get back the same advertisement that was previously rendered with a previous rendering of that Web page.

In addition, not only are these advertisements dynamically and randomly generated as discussed above, but these advertisements or messages also appear and disappear very quickly on the display screen. As such, they are also referred to herein as being transient or transitory banner advertisements or messages.

As such, these dynamically generated transient advertisements have an inherent problem as made evident in the situation where a user may be interested in a promotional message at a particular instance. Because these messages appear and disappear rather quickly, by the time a user tries to select a particular promotional message link, the message may have already flashed by as a different message appears. Hence, the user misses the desired links. This can be especially problematic for users having physical or mental disabilities that hinder the user from being able to respond quickly to these transient messages. As discussed above, because of the dynamic and random nature of the advertisements, a user can not just request the original document again and expect to see the same advertisement embedded therein. Consequently, a specific advertiser that the user was initially interested in may have lost a potential customer.

For example, FIG. 1A displays a Web page 100 with a message 101 appearing above the article to enroll in a Merryll Lynch program. FIG. 1B displays the same Web page 100 with a different message 102 appearing above the article to apply for a Yahoo/Visa card. The Yahoo/Visa message in FIG. 1B appears quickly, and thus the Merryll Lynch message in FIG. 1A is missed.

One solution to help users deal with transitory advertisements is called Banner Console by i-LOR; and it is described on the World Wide Web at i-lor.com/bannerconsole. A tool is added to a banner ad that allows the user to click once to enable the user to return to the banner ad later. The banner ad is saved and its image is listed in a separate window for later selection by a user. Multiple ads can be selected. Each ad selected by the user is added to the list of ads in the separate window.

Another solution is provided in copending patent application Ser. No. (AUS919990895US1) filed Apr. 27, 2000, titled “METHOD, SYSTEM, AND PROGRAM FOR SAVING OBJECT CONTENT IN A REPOSITORY FILE” and commonly assigned to IBM Corporation in which a displayed advertisement object can be selected by a user and appended to a repository file of similarly selected objects.

A problem with the above solutions, however, is that they require that a user view each ad as it is quickly displayed in order to make the decision of whether or not the user may want to view it later. This distracts the user from the current Web page that was requested by the user. The above solutions also do not solve the problem of a user reading the requested page content and missing an advertisement by not clicking on it.

### SUMMARY OF THE INVENTION

It is therefore desirable to enable a user to view, at a later time, transitory advertisements that a user may have missed.

The system, method, and program of the present invention each comprise saving multimedia objects that have been rendered by the Web browser within a configurable amount of time, displaying the list of saved multimedia objects, and allowing the multimedia objects to be rewound and replayed. The multimedia object may be requested through an URL, e.g., when embedded within another document, or be received via pull or push techniques from a server. The multimedia object may be one or more advertisements or other transient message. The multimedia objects may encompass video, streaming video, audio, animation, and/or a sequence of images including a sequence of images displayed by push techniques from a server, etc.

More specifically, the browser stores each multimedia object in a chronological list, during a configurable duration of time, as each multimedia object is rendered at the client. By selecting the advertisement area, such as by a right mouse click, or other predefined user action, a menu appears having the functional selections of stop, play, rewind, forward skip, reverse skip, etc. If a user selects “play”, the multimedia objects are rendered to the screen in chronological order from the beginning of the list or from a current position in the list. If a user selects “rewind”, the multimedia objects are rendered to the screen in reverse chronological order beginning from the last object stored in the list or from a current position in the list. If a user selects “forward skip”, a next object in the list becomes a current position. If a user selects “reverse skip” a previous object in the list becomes a current position. Movement through the list can occur through repeated selection of a given skip button. As such, a user can replay at a later time some or all of the stored multimedia objects.

Another embodiment of the invention is described in a copending patent application having Serial Number (Internal Docket No. AUS920010005US1) and filed on even date herewith and commonly assigned, and which is incorporated herein by reference. Instead of saving the multimedia objects, only screen captures of the various multimedia objects are saved at configurable time intervals. The screen captures contain the necessary links to access the advertiser. Upon playback the user will only see the stored screen captures. The user will not see the actual replaying of the multimedia object. Nevertheless, the user will have various identifiable snapshots of the advertisements and access to the necessary links to get back to a desired advertiser.

An advantage of the embodiments is that a user can replay transitory content that has been missed. A further advantage is that the content can be replayed at a speed that is different than originally rendered. This enables a person with a cognitive disability to replay the content at a slower speed, if desired.

### BRIEF DESCRIPTION OF THE DRAWINGS

For a more complete understanding of the present invention and the advantages thereof, reference should be made to the following Detailed Description taken in connection with the accompanying drawings in which:

FIGS. 1A and 1B are examples of transitory messages dynamically displayed in a Web browser as known in the art;

FIG. 2 illustrates a network environment of a preferred embodiment of the invention;

FIG. 3 illustrates an external representation of a browser window displayed to a user and a displayed list of stored multimedia objects;

FIG. 4 illustrates a network configuration of an embodiment of the invention having the rewind and replay feature at a server to access missed links that were dynamically and transiently displayed in browsers on a client side; and

FIG. 5 illustrates a browser at a client having an advertisement sent from the server with rewind and replay controls.

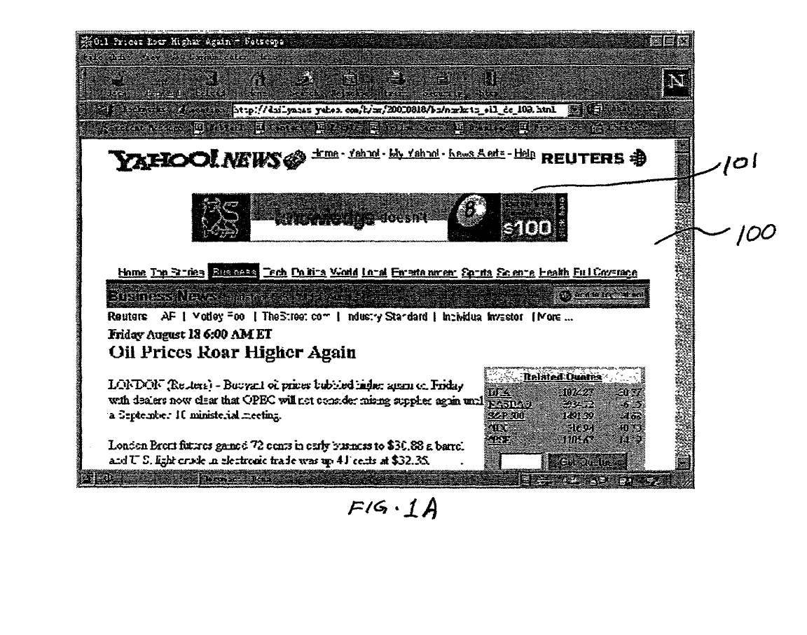

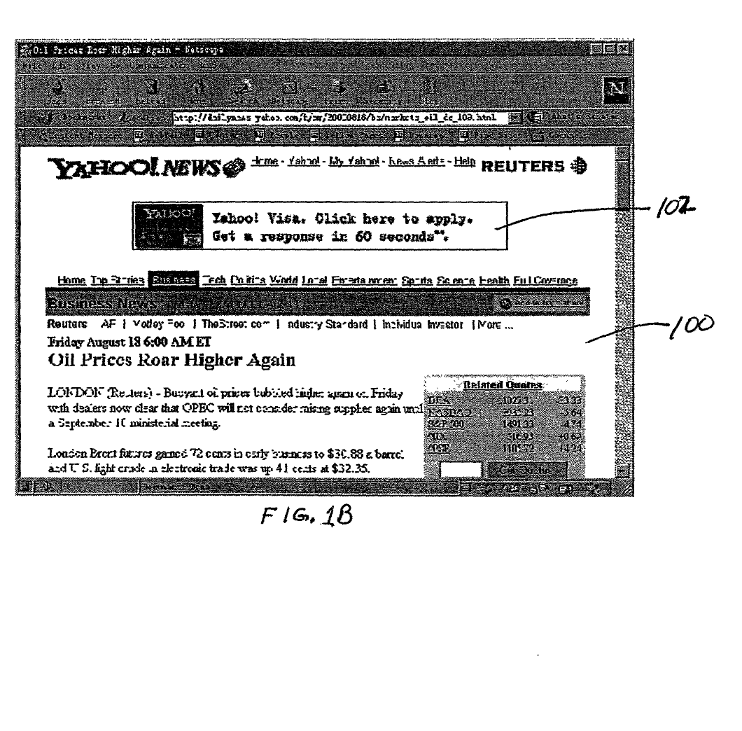

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

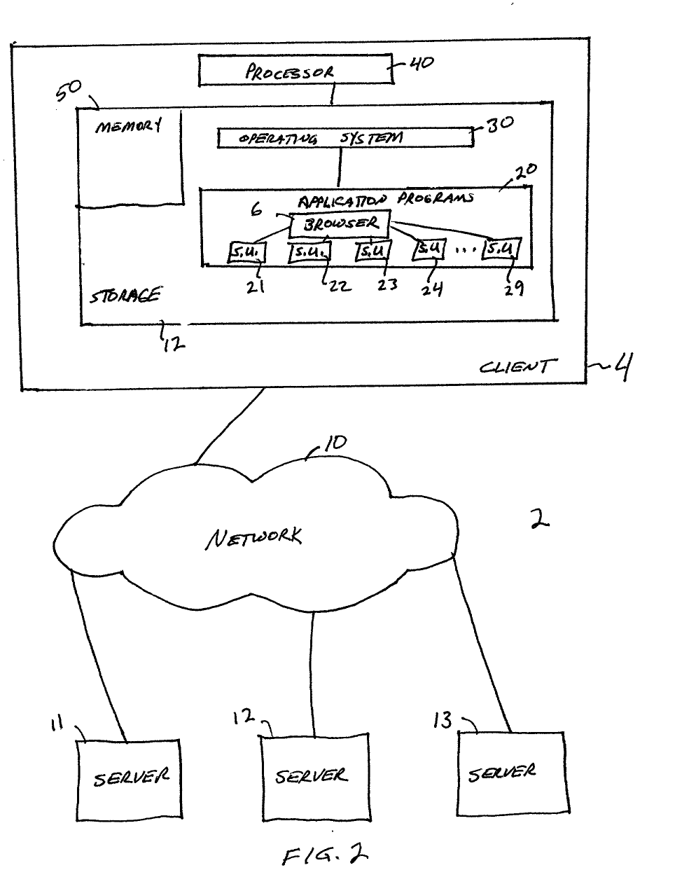

FIG. 2 illustrates a computing environment in which preferred embodiments are implemented. The computing environment 2 includes at least one client computer 4 including a browser program or viewer program 6, such as the Microsoft Explorer or Netscape Navigator, that is capable of retrieving files from servers 11, 12, 13 over a network 10. The client computer 4 may comprise any computer system known in the art capable of executing a browser program. The servers 11, 12, 13 may comprise any computer system known in the art capable of maintaining files and making such files accessible to remote computers. The browser 6 and servers 11, 12, 13 communicate using a document transfer protocol such as the Hypertext Transfer Protocol (HTTP), or any other document transfer protocol known in the art, such as FTP, Gopher, WAIS, etc. The network 10 may be made up of a TCP/IP network, such as the Internet and World Wide Web, or any network system known in the art, e.g., LAN, Ethernet, WAN, System Area Network (SAN), Token Ring, etc.

The client computer 4 may be, but is not limited to, a personal computer, laptop, workstation, mainframe or hand held computer including palmtops, personal digital assistants, smart phones, cellular phones, etc. Client computer includes processor 40 and memory 50. Memory 50 includes volatile or nonvolatile storage and/or any combination thereof. Volatile memory may be any suitable volatile memory device, e.g., RAM, DRAM, SRAM, etc. Nonvolatile memory may include storage space 12, e.g., via the use of hard disk drives, tapes, etc., for data, databases, and programs. The programs in memory include an operating system 30 and application programs 20 including a browser program 6 and software units 21-29 for displaying text and various types of multimedia objects as further discussed below. The browser program 6 displays a graphical user interface in which content from a file downloaded from one of the servers 11, 12, 13, such as a HTML page, is displayed. The browser GUI displays graphical buttons to perform operations related to the files in storage as further described herein.

The client computer 4 includes output devices (not shown) including a display for displaying the browser GUI and Web page and object content. The client computer also includes at least one input device (not shown) through which the user may enter input data to control the operation of the browser program 6, such as a keyboard, mouse, pen-stylus, touch sensitive screen, voice decoder for decoding voice commands, etc. In preferred embodiments, a user at the client computer 4 can input commands to control the browser program 6 through the graphical user interface (GUI) generated by the browser 6 or input device controls, such as keyboard keys, mouse buttons, touch pad regions, that are programmed to cause the browser to perform specific operations.

The exemplary embodiment shown in FIG. 2 is provided solely for the purposes of explaining the preferred embodiments of the invention; and those skilled in the art will recognize that numerous variations are possible, both in form and function.

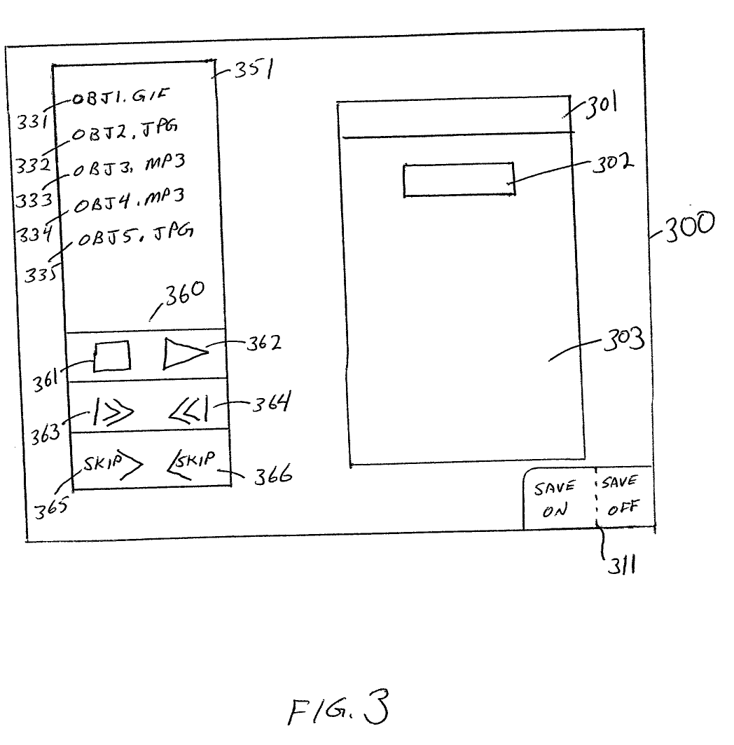

FIG. 3 illustrates an external representation of a browser window 300 having a URL field 301, a visual multimedia object area 302, and text 303. The object area 302 may support multimedia objects such as images, video, audio, graphics, and text. The software that enables this external representation includes a software unit for the multimedia object display (e.g., any one or more of software units (S.U.) 22-29 shown in FIG. 2), and a software unit (e.g., software unit 21 FIG. 2) for the text display. Each of the software units separately render the content for the visual multimedia object and the text area on the display screen by accessing the content from separate locations within the network.

The visual multimedia object 302 can be of a static image type or a moving picture type, e.g., a video. The moving picture can be constructed by rapidly showing a sequence of static images such as in a movie which may show a series of static frames at a rate of so many frames per second, e.g., 30 frames per second. All of these frames can be sent from a server. This represents how the real audio format MP3, or video format, are currently sent. However, sending so many frames for each second of display is typically an expensive way to send such data. Another way to send such multimedia data is to send a vector graphic program, such as SVG or Macromedia Flash, from a server which is then played by the browser. A third kind of multimedia object is an animated GIF which is a program which has certain characteristics which allows it to be animated by the software unit. Regardless of what type of moving picture is being sent—whether it is a sequence of static images or a program such as SVG, Macromedia Flash, or an animated GIF—it is always interpreted by a software unit for the given multimedia object.

For the display of multimedia objects, a software program is used such as Microsoft Multimedia Player, RealNetworks (Real Audio and Real Video), QuickTime by Apple, etc. In the user interface for such a player, a user would input a filename of the moving picture and the program would play it in a window. The multimedia program has user interface controls such as a forward button, backward button, fast forward button, fast reverse button, stop, and play, etc. For a given type of multimedia object, operations on the object such as play, rewind, etc., are known in the art. It should be noted that any given media player can only play the certain media types of files that it can interpret.

In operation, a Web browser issues a get command (e.g., GET X.HTML) to get back the document named X.HTML. The browser interprets the document, X.HTML, and determines that it includes a multimedia object (e.g., a multimedia object named obj1.xx where xx is the extension name which may be dependent on the type of multimedia object, e.g., GIF for a GIF object type). The browser then issues a GET for the multimedia object (e.g., GET obj1.xx) to get the object. The Web browser now has the document X.HTML and the multimedia object obj1.xx. The Web browser renders both of them on the screen using the software unit for text to render X.HTML and the appropriate software unit for rendering the multimedia object obj1.xx depending upon the type of multimedia object (e.g., GIF, .MP3, .JPG, .AU, .AVI, etc.). To accomplish this, the browser examines the extension of the multimedia object to determine which software unit is needed, e.g., a .GIF renderer, or a .MP3 renderer, etc., to run the multimedia object through to render it. The client has the renderers, i.e., software units, needed to interpret and render most types of multimedia objects.

As previously discussed, a given multimedia object may only be rendered for a relatively short period of time, thereby appearing to the user as transient content. For example, the user may request a new Web page that has a different multimedia object embedded within or no multimedia object at all, such that any multimedia object previously rendered goes away when the new page is rendered. In addition, a given multimedia object may be comprised of a succession of different content so that it appears to the user that different multimedia objects are being rendered in succession.

In order to assist the user in being able to view at a later time transient content contained in a multimedia object embedded within a Web page, a preferred embodiment of the system, method, and program of the present invention enables a Web browser to automatically keep a list of what objects have arrived at the browser over a configurable duration of time.

Referring again to FIG. 3, when the feature to save transient content is set on, such as through a special control or button 311 in the browser GUI or through a pull down menu in the browser GUI, the browser automatically stores each object without a user first having to select each object to be stored. The time period (such as a minute, five minutes, thirty minutes, etc.) for which a browser keeps track of the objects can be configured initially via a default time or later changed or set by the user. The user can also set the duration manually by selecting or deselecting control 311. The different multimedia objects 331-335 that were rendered in the multimedia region 302 are stored in a list 351 in memory preferably at the client. The object names are stored in chronological order with respect to a time in which they were rendered. For some embodiments, the time rendered and/or duration of time a given object was rendered may also be displayed along with the object name. Furthermore, in addition to, or in place of, the object name in the list, the list may contain a thumbnail of the object, i.e., a small region showing a static frame of the multimedia object content.

The list is displayed when the multimedia region 302 of the browser is selected by the user such as through a mouse click. Upon a selection by the user of an object within the list, the browser will render again the selected object from local memory by utilizing the software unit associated with the type of multimedia object selected. The controls—play, rewind, stop, fast forward, etc.,—enabled by the specific software unit will be utilized in playing back the selected object. When the object is selected, a menu opens up with these controls for selection by the user enabling the user to select the desired function such as play, rewind, etc.

In addition, the displayed list 351 also displays playback controls 360 such as stop 361, play 362, fast forward 363, rewind 364 and forward skip 365 or reverse skip 366. For instance, if play 362 is selected, the browser renders the first object 331 in the list and plays it using the appropriate software unit for that type of object. If the object has been played and the “play” button 362 is still selected, the browser renders the next object in the list 332 using its corresponding software unit. If the user selects stop, a signal is sent to the software unit to stop playing the object. If the user selects the forward skip button 365 once, then the next object in the list, obj3.mp3 333, is highlighted. If the user selects the skip forward button 365 repeatedly two more times, then obj5.jpg, 335, is highlighted and automatically played or played when the play button 362 is selected. As such, if play 362 is selected, then obj5.jpg 335 is rendered using the appropriate software unit. If rewind 364 is selected, then the previous object 334 in the list is played. When the object 334 has played, each of the preceding objects 333-331 will be successively highlighted and played until either the first object 331 in the list has finished playing or the stop button 361 is selected, in which case the object which was highlighted when the stop button 361 was selected will remain highlighted and become the current position. Through the use of the playback controls 360, a user is able to manipulate the playing back of the stored transient objects at a rate as desired by a user, including a slower rate which would be desirable for users having cognitive disabilities.

As such, the browser maintains a list of all of the objects that have been received and rendered within a configurable duration of time, the time that the object was initially rendered, and the time that it took to initially play the object. The browser stores this list of objects, and the objects themselves, in storage that is preferably local to the browser. Depending upon the size of local storage available at the client, local storage should be adequate for a few minutes of saved multimedia objects. If not, or if a longer time is specified, the browser may utilized storage using a communication link to other devices. For example, if the advertisement is a video, it is easy to save locally since the video file is already in the browser. If the advertisement is a rapid succession of still frames, the old frames may not necessarily be stored in the browser cache. In this situation where the dynamic image is not in cache, a selection of the replay feature by a user would cause an HTTP request to be sent to the server, and the appropriate image(s) would be downloaded from the server when they are replayed.

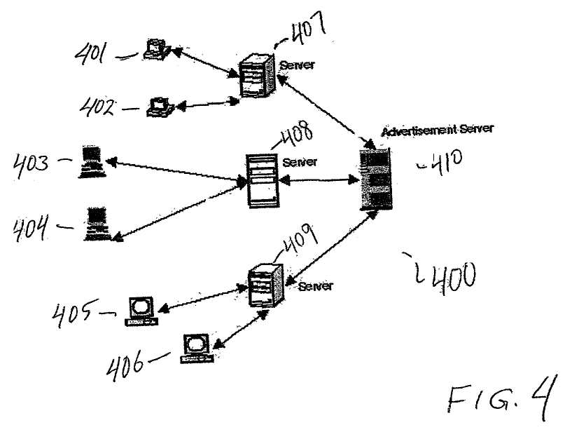

Although the above embodiment implements the present invention at each client, other embodiments may be used that implement the invention at a server. The following describes an embodiment of the rewind and replay feature at a server to access missed links that were dynamically and transiently displayed in browsers on a client side. FIG. 4 illustrates a network configuration 400 wherein client desktops 401-406 are connected to servers 407-409 which in turn are connected to an advertisement server 410. In a preferred embodiment, the server 410 stores the multimedia advertisement objects in a last in first out (LIFO) queue. It should be noted that other embodiments could store the objects in other sequences including a first-in-first out (FIFO) queue. As such, for the preferred embodiment, when a user selects the rewind feature of the invention to replay the missed advertisements, the last multimedia object that was previously displayed at the client and the last one to be saved is the first one to be replayed to the user. For each activation by the user of the rewind button, the server sends a multimedia object from the LIFO queue with the specific controls to rewind or replay each separate multimedia object. That is, the server sends to the client the data (i.e., the multimedia object) and its corresponding program or software unit to interpret the data, i.e., to play or rewind the multimedia object. Although the program to interpret the data normally is found at the client, in the embodiment herein described, it is sent from the server. As such, any play or rewind buttons would be part of the multimedia object, or associated with the object, and displayed in the area of a document designed for the multimedia object. In other words, if implemented at the server, the server can take into account the screen real estate needed for the rewind and replay controls associated with the multimedia objects. The documents at the server are designed to take this into account. The placement and flow of the text allows space for such controls.

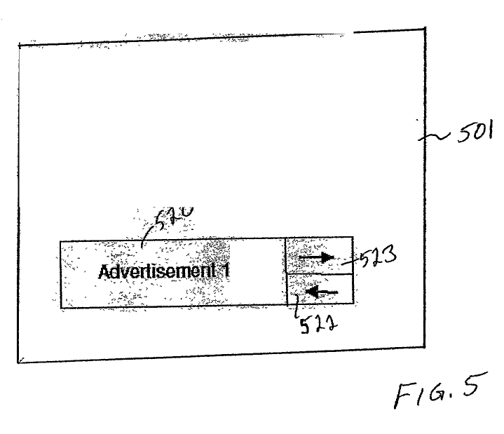

FIG. 5 displays an advertisement 520 in a window 501 that can be incorporated in the browser or in a separate window. The previous or the next advertisement can be accessed via single click on the left arrow 522 or the right arrow 523 at the client side (e.g. clients 401-406, FIG. 4). By selecting either the left or the right arrow (522, 523), a signal is sent to the appropriate server 407, 408, or 409. When selected, the left and right arrows 522, 523 will cause the server to move in different directions (forward or backward) through the queue of stored multimedia objects in order to retrieve a previous or next multimedia object. Servers 407-409 contain replicates of the original advertisements at advertisement server 410 in order to balance the incoming network requests coming from clients for replaying the advertisements. The appropriate server will send the advertisement from the queue to be displayed on the client side. Thus the rewind feature is implemented at the server side (server 407-409 or the advertisement server 410) such that the previously dynamically displayed messages or missed links can be displayed at the client side. In another preferred embodiment, the advertisement server is connected to the client directly.

The preferred embodiments may be implemented as a method, system, or article of manufacture using standard programming and/or engineering techniques to produce software, firmware, hardware, or any combination thereof. The term “article of manufacture” (or alternatively, “computer program product”) as used herein is intended to encompass data, instructions, program code, and/or one or more computer programs, and/or data files accessible from one or more computer usable devices, carriers, or media. Examples of computer usable mediums include, but are not limited to: nonvolatile, hard-coded type mediums such as read only memories (ROMs) or erasable, electrically programmable read only memories (EEPROMs), recordable type mediums such as floppy disks, hard disk drives and CD-ROMS, and transmission type mediums such as digital and analog communication links, or any signal bearing medium.

The foregoing description of the preferred embodiments of the invention has been presented for the purposes of illustration and description. It is not intended to be exhaustive or to limit the invention to the precise form disclosed. Many modification and variations are possible in light of the above teaching. For example, although preferred embodiments of the invention have been described in terms of the Internet, other network environments including but not limited to wide area networks, intranets, and dial up connectivity systems using any network protocol that provides basic data transfer mechanisms may be used.

Also, preferred embodiments were described with respect to the HTTP protocol for transmitting documents between computers within a network. However, those skilled in the art will appreciate that the preferred embodiments may apply to any communication protocol for allowing a client to request and access files in a network environment.

In preferred embodiments, the documents or objects (“files”) being retrieved were identified by a URL address and may be located on different servers connected over a common network such as the Internet. In alternative embodiments, any file addressing scheme may be used, including a file pathname indicating the location of a file in storage.

Preferred embodiments were described with respect to a browser program for displaying files downloaded from over a network, such as the Internet. However, in alternative embodiments, the browser program may be any viewer program, not just Internet Web browsers, that are capable of accessing and displaying locally files retrieved from a server over a network.

The preferred embodiment has been described with dynamic advertisements (multimedia objects) associated with hyperlinks. This is a common way of displaying dynamic advertisements on a browser. However, there are other ways now (and in the future that may be developed) to display dynamic advertisements or multimedia objects on a browser. In the situation where advertisements are directly displayed in a browser without the aid of a hyperlink embedded within a HTML page that is downloaded by the browser software, the method of the invention can still be applied by various mechanisms. These would comprise identifying and clipping the region associated with dynamic advertisements; saving them over time; optionally associating artificially created identifying tags with these saved entities when needed; and finally displaying them under user control at a later time. Depending on whether the method is performed at the client or server, variations of the method could be used. The essence of the invention is to display dynamic images in a web page under user control. The invention is applicable to all dynamic images regardless of whether or not hyperlinks are associated with the multimedia objects.

A multimedia object can also consist of a separate frame in the same browser that, on a timer, updated its content and linked to the content via the DOM or a scripting language, or any other programmable segment, which dynamically changed an HTML object and its HREF link.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Having thus described the invention, what we claim as new and desire to secure by Letters Patent is set forth in the following claims.

1. A method for displaying, at a client, transient messages received over a network, the method comprising:
storing, independently of a user action, each one of at least one multimedia object containing at least one transient message when each multimedia object is initially rendered at the client; and
enabling a subsequent rendering of at least one of the stored multimedia objects containing at least one stored transient message in response to a user selection.

2. The method of claim 1 wherein the at least one multimedia object is at least one of an animated GIF multimedia object, a moving picture type multimedia object, a vector graphic multimedia object, and a static image multimedia object.

3. The method of claim 1 wherein the step of storing further comprises storing at least one of the multimedia objects at the client.

4. The method of claim 1 wherein the step of storing further comprises storing at least one of the multimedia objects at a server which is in communication over the network with the client.

5. The method of claim 1 wherein the step of enabling a subsequent rendering of at least one of the stored transient messages in response to a user selection further comprises replaying a transient message in response to a user selection of a named multimedia object from a list of the saved multimedia objects displayed at the client.

6. The method of claim 1 wherein the step of enabling a subsequent rendering of at least one of the stored transient messages in response to a user selection further comprises replaying a sequence of a plurality of the stored multimedia objects on a display at the client in response to the user selection of a control button associated with a list of the saved multimedia objects displayed at the client.

7. The method of claim 1 wherein the storing step occurs for a configurable duration of time.

8. The method of claim 1 wherein the step of storing further comprises storing at a server, which is communicatively connected over the network with the client, each of the multimedia objects in a queue as each multimedia object is initially rendered at the client.

9. The method of claim 8 further comprising sending a given multimedia object from the queue and a corresponding software unit to enable the multimedia object to be played in response to a selection of a replay button sent from the server to be displayed at the client in conjunction with the multimedia object in an area of a document allocated to the multimedia object.

10. A computer program product having computer readable program code means on a computer usable medium having instruction means for enabling a display, at a client, of transient messages received over a network, comprising:
instructions for storing, independently of a user action, each one of at least one multimedia object containing at least one transient message when each multimedia object is initially rendered at the client; and
instructions for enabling a subsequent rendering of at least one of the stored multimedia objects containing at least one stored transient message in response to a user selection.

11. The program product of claim 10 wherein the instructions for enabling a subsequent rendering of at least one of the stored transient messages in response to a user selection further comprises instructions for displaying a list of the stored multimedia objects and replaying a transient message in response to a user selection of a named multimedia object from the list.

12. The program product of claim 10 wherein the instructions for enabling a subsequent rendering of at least one of the stored transient messages in response to a user selection further comprises instructions for enabling a replaying of a sequence of a plurality of the stored multimedia objects on a display at the client in response to the user selection of a control button.

13. The program product of claim 10 wherein the instructions for storing further comprises instructions for storing at a server, which is communicatively connected over the network with the client, each of the multimedia objects in a queue as each multimedia object is initially rendered at the client.

14. The program product of claim 10 further comprising instructions for sending a given multimedia object from the queue and a corresponding software unit to enable the multimedia object to be played in response to a selection of a replay button sent from the server to be displayed at the client in conjunction with the multimedia object in an area of a document allocated to the multimedia object.

15. A computer system having means for displaying, at a client, transient messages received over a network, the system comprising:
means for storing, independently of a user action, each one of at least one multimedia object containing at least one transient message when each multimedia object is initially rendered at the client; and
means for enabling a subsequent rendering of at least one of the stored multimedia objects containing at least one stored transient message in response to a user selection.

16. The computer system of claim 15 wherein the at least one multimedia object is at least one of an animated GIF multimedia object, a moving picture type multimedia object, a vector graphic multimedia object, and a static image multimedia object.

17. The computer system of claim 1 wherein the means for enabling a subsequent rendering of at least one of the stored transient messages in response to a user selection further comprises means for replaying a transient message in response to a user selection of a named multimedia object from a list of the saved multimedia objects displayed at the client.

18. The computer system of claim 15 wherein the means for enabling a subsequent rendering of at least one of the stored transient messages in response to a user selection further comprises means for replaying a sequence of a plurality of the stored multimedia objects on a display at the client in response to the user selection of a control button associated with a list of the saved multimedia objects displayed at the client.

19. The computer system of claim 15 wherein the means for storing further comprises means for storing at a server, which is communicatively connected over the network with the client, each of the multimedia objects in a queue as each multimedia object is initially rendered at the client.

20. The computer system of claim 19 further comprising means for sending a given multimedia object from the queue and a corresponding software unit to enable the multimedia object to be played in response to a selection of a replay button sent from the server to be displayed at the client in conjunction with the multimedia object in an area of a document allocated to the multimedia object.

21. A method for redisplaying, at a client, at least one transient message displayed in a browser, the method comprising:
identifying a region associated with the at least one transient message;
clipping the region associated with the at least one transient message;
storing, independently of a user action, each transient message when each transient message is initially rendered by the browser; and
enabling a subsequent rendering of at least one of the transient messages in response to a user selection.

22. The method of claim 21 further comprising associating a separate identifier for each stored transient message; and enabling a use of the identifier for the user selection.

23. A computer system having means for redisplaying at least one transient message displayed in a browser, the system comprising:
means for identifying a region associated with the at least one transient message;
means for clipping the region associated with the at least one transient message;
means for storing, independently of a user action, each transient message when each transient message is initially rendered by the browser; and
means for enabling a subsequent rendering of at least one of the transient messages in response to a user selection.

24. A computer program product having computer readable program code means on a computer usable medium having instruction means for enabling a redisplaying of at least one transient message displayed in a browser, the computer program comprising:
instruction means for enabling an identification of a region associated with the at least one transient message;
instruction means for enabling a clipping of the region associated with the at least one transient message;
instruction means for storing, independently of a user action, each transient message when each transient message is initially rendered by the browser; and
instruction means for enabling a subsequent rendering of at least one of the transient messages in response to a user selection.
